(19) United States
(12) Patent Application Publication
(10) Pub. No.: US 2012/0037571 A1
(43) Pub. Date: Feb. 16, 2012

(54) METHOD AND APPARATUS FOR SANITIZING WATER USING AN ULTRAVIOLET LIGHT

(76) Inventor: Perry D. Felix, Houston, TX (US)

(21) Appl. No.: 13/148,572

(22) PCT Filed: Feb. 10, 2010
(86) PCT No.: PCT/US10/23761

§ 371 Date: Nov. 3, 2011

Related U.S. Application Data
(60) Provisional application No. 61/151,270, filed on Feb. 10, 2009.
(60) Provisional application No. 61/233,739, filed on Aug. 13, 2009.

(51) Int. Cl. C02F 1/32

(52) U.S. Cl. 210/748.11; 250/432 R; 250/373; 250/435

(57) ABSTRACT

The present invention provides a method and apparatus for sanitizing consumable water using an ultraviolet light. The water is exposed to the ultraviolet light for a preselected duration of time and at a desired power level to achieve a desired level of sanitization.

### BACKGROUND OF THE INVENTION

1. Field of the Invention

This invention relates generally to sanitizing water, and, more particularly, to sanitizing water using ultraviolet light.

2. Description of the Related Art

Water is a vital commodity, necessary for human life. Communities throughout the world are actively engaged in providing water to its residents to use for drinking, bathing, cooking, or other basic needs. Communities typically access a source of raw water, purify the water and then distribute the water throughout the community via a municipal water supply.

This raw water may be obtained from a variety of sources in various communities throughout the world. For example, raw water may be obtained from wells in the form of groundwater, or surface water from upland lakes and reservoirs, rivers, canals, low land reservoirs, etc. Typically, the raw water may contain undesirable chemical and biological contaminants that need to be removed via water purification. Most water is purified for human consumption, but water purification may also be designed for a variety of other purposes, including meeting the requirements of medical, pharmacology, chemical and industrial applications. In general, prior art purification methods include a combination of: physical processes, such as filtration and sedimentation; biological processes, such as slow sand filters or activated sludge; and chemical processes, such as flocculation and chlorination. Purification is intended to reduce the presence of contaminates, such as suspended particles, parasites, bacteria, algae, viruses, fungi, etc.

The ramifications of unsanitary water are severe. Various sources report that as many as 1.1 billion people lack access to an improved drinking water supply, 88% of the 4 billion annual cases of diarrheal disease are attributed to unsafe water and inadequate sanitation and hygiene, and 1.8 million people die from diarrheal diseases each year. The World Health Organization estimates that 94% of these diarrheal cases are preventable through modifications to the environment, including access to safe water.

Moreover, terrorists and radical groups continue to threaten the safety of the general population. At least one oft-mentioned attack is the purposeful introduction of biological components to contaminate public water supplies, water sources and water treatment facilities.

Current chemical purification offers some protection from the various hazards of contaminated water, but chemical disinfectants, such as chlorine, are costly to produce and use and also produce by-products or contaminates that may be harmful to both the individuals dispensing the chemicals as well as those consuming the water. Further, the chemical disinfectants are not earth or environmentally friendly and consume resources.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment of the instant invention, a method is provided for sanitizing water. The method comprises directing ultraviolet light into a conduit capable of carrying water therein; measuring an intensity of the ultraviolet light within the conduit; and controlling the intensity of the ultraviolet light introduced into the conduit based on the measured intensity of ultraviolet light within the conduit to provide sanitized water.

In another embodiment of the instant invention, a method is provided for sanitizing water. The method comprises directing ultraviolet light into a conduit capable of carrying water therein; measuring a parameter of the water within the conduit associated with sanitization of the water; and controlling the intensity of the ultraviolet light introduced into the conduit based on the measured parameter of the water.

In still another embodiment of the instant invention, an apparatus is provided for sanitizing water. The apparatus comprises: a container for housing water; an ultraviolet light; and means for transmitting the ultraviolet light into the container housing the water.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1A conceptually illustrates a block diagram that stylistically depicts one embodiment of the instant invention;

FIG. 1B conceptually illustrates one embodiment of a flowchart that may function to control the operation of the instant invention shown in FIG. 3A;

FIGS. 2A-2B conceptually illustrate alternative embodiments of the instant invention with ultraviolet let being directed coaxially with a conduit;

FIG. 3A conceptually illustrates a block diagram that stylistically depicts one embodiment of the instant invention that includes a mechanism for disturbing the flow of water within a conduit;

FIG. 3B conceptually illustrates one embodiment of a flowchart that may function to control the operation of the instant invention shown in FIG. 3A;

FIGS. 4A-4B conceptually illustrate alternative embodiments of the instant invention with ultraviolet let being directed coaxially with a conduit;

FIG. 5 conceptually illustrates a block diagram that stylistically depicts one embodiment of the instant invention that includes an arrangement for introducing ultraviolet light in a bath;

FIGS. 6A-6G conceptually illustrate alternative embodiments of the instant invention with ultraviolet light being emitted by a vertical cavity surface emitting laser; and

FIG. 7 conceptually illustrates one embodiment of a flowchart that may function to control the operation of the instant invention shown in FIGS. 6A-6G.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this Disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

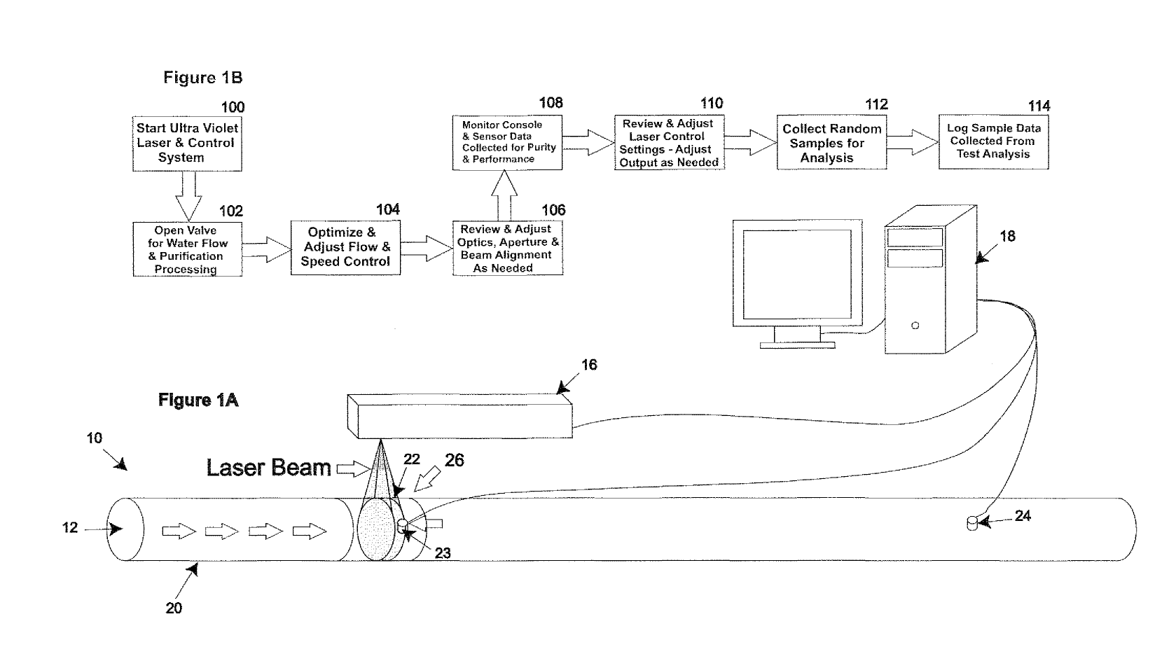

FIG. 1A conceptually illustrates a first exemplary embodiment of the instant invention. Generally, a system 10 is provided to sanitize raw water 12 while the water is being prepared for distribution to a community. The system 10 includes an ultraviolet (UV) light source, such as a laser 16 operating under the control of a computer control system 18 to dispense UV laser light into the water while the water is contained, such as by a conduit, pipe 20, tank, or other container.

The UV laser 16 may take on any of a variety of forms, but generally, a common wavelength for the UV laser 16, when used in a sanitizing application, is in the range of about 266 nm to about 355 nm, which those skilled in the art will appreciate includes near UV wavelengths of about 220 nm to about 400 nm, far UV wavelengths of about 190 nm to about 220 nm, and VAC UV wavelengths of about 90 nm to about 190 nm. Depending on the area of coverage and/or size of the container, conduit, pipe or tank, turbidity of the water, and flow rate, the power of the UV laser 16 may range from as little as 2 mW to hundreds or even thousands of watts of UV laser power. In one exemplary embodiment of the instant invention, a UV laser 16 operating at about 355 nm wavelength proved to be highly effective in sanitizing contaminated water to achieve an effective purity rate as high as 99.7% for killing bacteria, viruses, mold, fungi and insect larvae. In one particular embodiment, the UV laser may take the form of Model No. DP-UV-355 available from Han's Laser and may be comprised of an array of one or more lasers.

The UV laser light may be distributed within the pipe 20 using a variety of mechanical and/or optical systems. For example, a rotating or oscillating mirror may be used to reflect the laser light through a port 22 in the pipe 20 to create a pattern of light that effectively exposes the water 12 to the laser light regardless of the location of the water 12 within the pipe 20. FIG. 1A illustrates the laser light being distributed in a circular pattern for illustrative purposes only. Those skilled in the art will appreciate that the laser light could be distributed in a variety of patterns, such as square, rectangular, linear, raster scan or even random patterns in order to effectively expose the water 12 to the UV laser light.

It is anticipated that some embodiments of the invention may utilize a plurality of UV lasers 16. Moreover, when multiple UV lasers 16 are employed, they may be selected to have substantially similar or substantially different wavelengths. In some embodiments, it may be useful to provide two or more UV lasers 16 irradiating the water 12 at substantially the same location with substantially similar wavelengths to achieve higher power levels. Alternatively, in some embodiments, it may be useful to provide two or more UV lasers 16 irradiating the water 12 at different, spaced apart locations to achieve greater coverage. Further, some embodiments of the instant invention may utilize two or more UV lasers 16 that operate at different wavelengths to expose the water 12 to a wider range of UV laser light in cases where the various contaminants are eradicated more effectively by different frequencies of UV laser light.

The computer control system 18 may take on any of a variety of forms, including but not limited to conventional desktop computers, laptop computers, servers, minicomputers, controllers, and the like. The computer control system 18 may be comprised of a microprocessor, memory, a display, and input or pointing devices, such mice, keyboards, touch sensitive pads or screens and the like.

In one embodiment of the instant invention, the computer control system 18 operates to control various parameters of the system 10 to insure an effective kill rate. For example, a laser power sensor 24 may be disposed to sense actual laser power being delivered to the water 12 in the pipe 20. The laser power sensor 24 provides feedback to the computer control system 18. The computer control system 18 may then vary a signal delivered to the laser 16 to raise or lower the power of the UV laser 16, as desired. Additionally, the flow rate of the water 12 in the pipe 20 may likewise be adjusted according to the actual laser power detected by the laser power sensor 24. For example, the computer control system 18 may reduce the flow rate of the water 12 in response to detecting reduced UV laser power, and/or control upstream processes to affect water parameters, such as turbidity. For example, the computer control system may send a signal to an upstream process that is designed to clarify the water.

Those skilled in the art will appreciate that clear water will more readily pass the UV laser light than will more turbid water. Those skilled in the art will appreciate that UV laser power may be increased throughout the pipe 20 by increasing water clarity. FIG. 1B illustrates an exemplary embodiment of a control sequence that may be implemented, at least partially, within the computer control system 18. The process begins at block 100 with water flow being provided through the pipe 20. At block 102, the computer control system 18 selects or establishes a desired flow rate of the water 12. At block 104, the UV laser 16 is enabled, and various parameters of the UV laser 16 are adjusted, either manually, or by the computer control system 18 at block 106. For example, it may be useful to set the laser and optics focus adjustment, aperture beam alignment, and divergence. At block 108, the computer control system 18 sets the laser output power based on feedback of digital signals received from the irradiance monitor which detects concentrations of UV laser energy levels and provides continuous feedback of UV energy relayed to the logic control of the computer to maintain stable and effective levels of laser power 16 required for safe purification and sanitization of the water source. Periodically, the computer control system 18 will receive a control signal from the laser power sensor 24, and use that signal to adjust various parameters of the UV laser 16 to achieve the desired sanitization of the water 12. For example, at block 110 the computer control system 18 may set or adjust a pulse width, a repetition rate, and/or tune the frequency wavelength of the UV laser 16. These parameters may be adjusted as necessary to maintain a desired level of UV laser power in the pipe 20.

It may also be useful to periodically test the water 12 to determine the effectiveness of the sanitizing process. Thus, at block 112, the results of this testing may be input into the computer control system 18 and used to further control the sanitizing process. For example, if the testing indicates an undesirable level of contamination in the sanitized water 12, then the computer control system 18 may further adjust the parameters of the system to produce a greater level of sanitization, such as by reducing the flow rate of the water 12, increasing the power of the UV laser 16 and/or increasing the clarity of the water 12.

Additionally or alternatively, it may be useful to route the water 12 through one or more additional sanitizing steps, depending upon the results of the testing. For example, inadequately sanitized water 12 may be passed through the same laser sanitizing process, or alternatively through a second similarly arranged system 10.

It is anticipated that the instant invention may find application in a variety of systems, such as municipal water systems and/or bottled water facilities. Those skilled in the art will appreciate that once the sanitization of the water 12 has been completed to a satisfactory level, and then the water 12 is directed to users of the commercial water system or packaged and shipped to customers, such as is shown in block 114.

In various alternative embodiments of the instant invention, it may be useful to provide a plurality of paths for the laser light to traverse from one or more UV lasers 16 to the water 12. In this manner, a more complete exposure of the water 12 to the laser light may be accomplished. For example, various laser light paths may be accomplished by routing the laser light through flexible fiber optic links or through other conventional optical devices, such as mirrors, splitters, and the like, to pass through multiple ports 24 distributed at various locations longitudinally along the pipe or at various locations distributed about the periphery of the pipe 20.

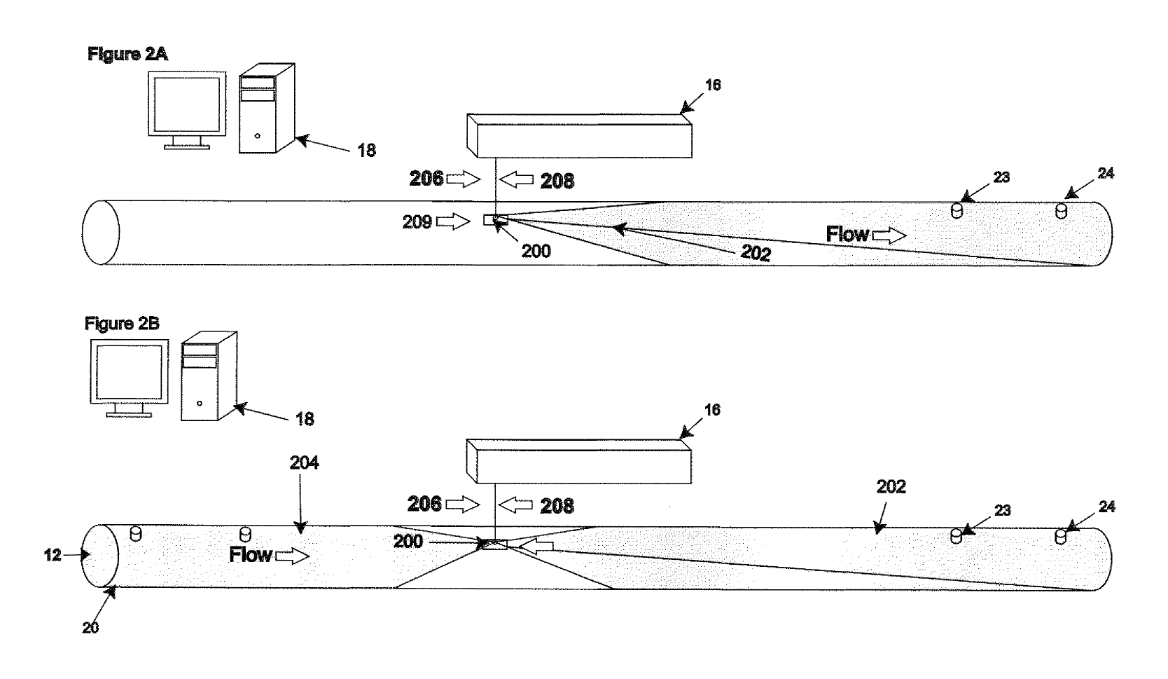

Alternatively, turning first to FIG. 2A, the laser 16 projects laser light through one or more optical devices 200, such as fiber optic cables, beam splitters, mirrors, or the like, to produce one or more beams of laser light 202 extending along a line generally longitudinally aligned with the pipe 20 in either an upstream or downstream direction. These beams of laser light 202 may be configured by the optical devices 200 to diverge and flood the pipe 20 with UV laser light along the length of the pipe 20. In one embodiment of the instant invention, it may be useful to form at least a portion of the interior of the pipe 20 be coated with or formed from a reflective or refractive material to cause the UV laser light to reflect or bend back toward the interior of the pipe 20 and thereby provide greater coverage of the interior of the pipe 20 with the UV laser light.

FIG. 2B illustrates an alternative embodiments of the instant invention in which multiple laser light paths are presented within the pipe 20. In the illustrated embodiment of the instant invention, at least a portion of the UV laser light is passed in both an upstream and downstream direction within the pipe 20. The optical devices 200 may be arranged to produce one or more beams of laser light 202, 204 extending along a line generally longitudinally aligned with the pipe 20 in both the upstream and downstream directions.

These beams of laser light 202, 204 may be configured by the optical devices 200 to diverge or expand and flood the pipe 20 with UV laser light along the length of the pipe 20. In this manner, water 12 may be more thoroughly exposed to the sanitizing effect of the UV laser as focused coherent UV laser beams provide light energy and power at sufficient concentration and density at great depths to effectively illuminate and sanitize the water and therefore completely eliminates the need for using hazardous chemicals in large volume systems. The UV laser sanitizing systems shown in many flexible designs are easily implemented and adopted to a wide variety of existing water treatment systems or municipal plants to efficiently and effectively irradiate and eradicate ALL impurities without further need or use of chemicals treatments.

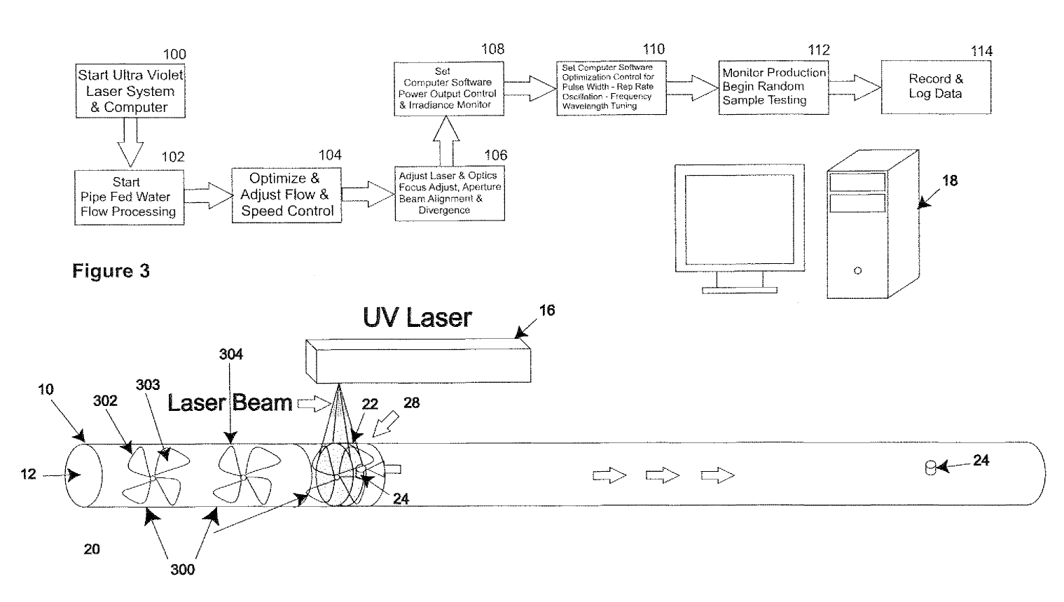

In various alternative embodiments of the instant invention, it may be useful to disturb the water 12 and any contaminates contained therein to insure that the contaminants within the water 12 are thoroughly exposed to the UV laser light. Turning now to FIG. 3, a first embodiment of a system that disturbs the water 12 in the pipe 20 is described. In the illustrated embodiment, the pipe 20 includes a mechanism 300 for creating turbulence in the water within the pipe 20. In this manner, contaminants within the water 12 become reoriented, exposing previously hidden surfaces to the UV laser light and enhancing the sanitizing effect of the UV laser light. The turbulence creating mechanism 300 may take on any of a variety of forms, such as devices that adjust the flow rate of the water 12, alter the path of the water 12, and the like. In one embodiment of the instant invention, a fan or propeller structure 302 may be positioned within the pipe 20. The propeller 302 may be freewheeling, and thus, it is turned by the force of the water flowing therethrough, or it may be driven to induce a stirring action in the water 12. In some embodiments of the instant invention, it may be useful to employ a plurality of propellers 302. In embodiments of the instant invention that employ either single or plural propellers 302 mounted or contained within the pipe 20, it may be useful to utilize propellers 302 constructed of highly polished stainless steel 303 or other materials having a highly reflective or coated finish. Likewise, the interior surface of the pipe 20 may also be made from or coated with similarly highly reflective materials to provide reflective interior surfaces 304. In this manner, laser light directed to the propellers 302 may be reflected therefrom, thereby increasing angles of incidence of the UV laser beams within the pipe segment and improving overall pervasiveness of laser light irradiation for more effective water sanitization.

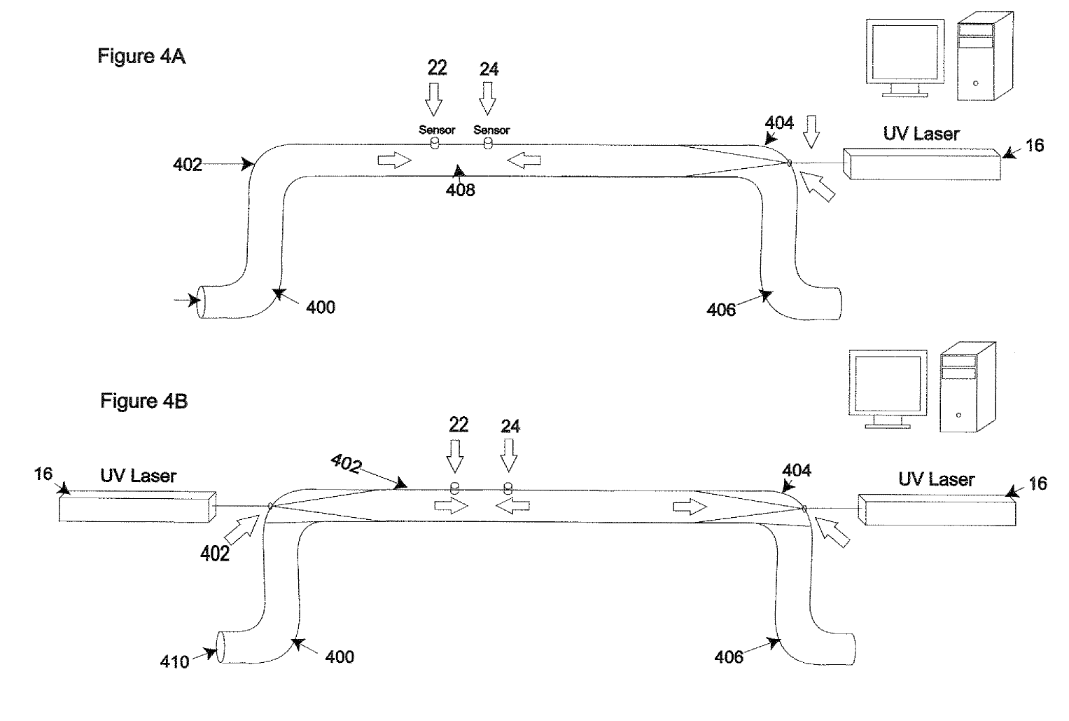

Turning now to FIGS. 4A and 4B, alternative embodiments of the instant invention are shown. FIGS. 4A and 4B illustrate alternative embodiments of the instant invention in which water is sanitized by UV laser light that is transmitted substantially along the direction of flow of the water within the pipe 20. In the illustrated embodiments, the pipe 20 is 15 modified to include a plurality of curved or bent sections 400, 402, 404, 406 to produce a linear region 408 that is offset from the main path 410 of the pipe 20. This arrangement allows the UV laser light to be readily introduced into the linear region 408 by optically coupling the laser 16 at the curved sections 402, 404. This configuration allows the UV laser beam to be introduced along a line generally longitudinally aligned with the pipe 20 in either 20 the upstream direction (as shown in FIG. 4A) or both the upstream and downstream directions (as shown in FIG. 4B). These beams of laser light 202 may be configured by the optical devices 200 to diverge and flood the linear region 408 of the pipe 20 with UV laser light along a substantial portion of the length of the pipe 20.

Those skilled in the art will appreciate that the curved sections 400, 402, 404, 406 may advantageously introduce turbulence into the water 12 within the linear region 408 of the pipe 20. As discussed previously, this turbulence produces a mixing effect that may further disturb the contaminants so that they are more thoroughly exposed to the UV laser light to produce a greater sanitizing effect.

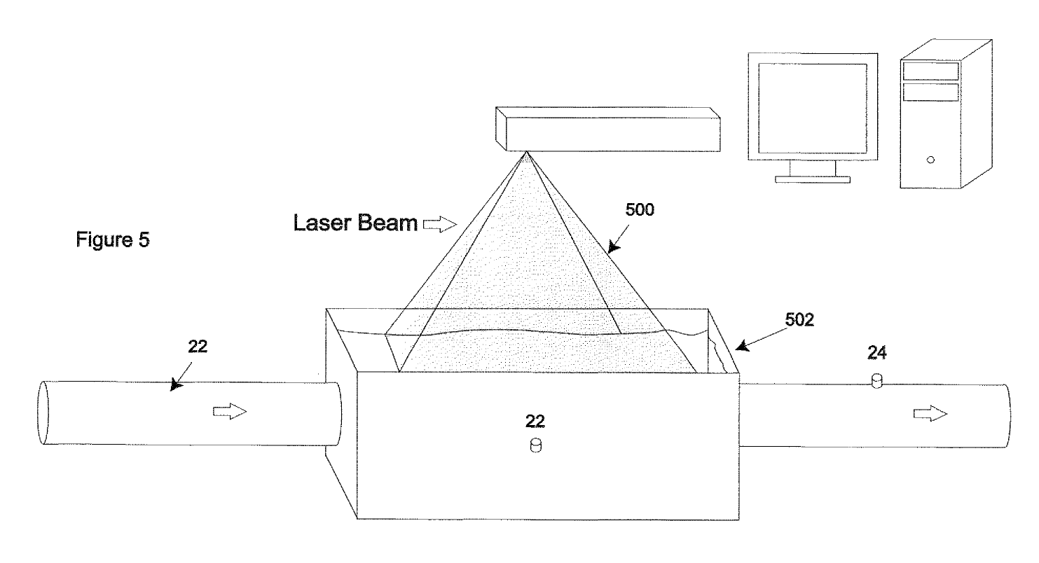

FIG. 5 illustrates an alternative embodiment of the instant invention in which water is sanitized by UV laser light 500 transmitted into a bath 502 rather than the conduit 504. In this embodiment of the instant invention, the laser light 500 is expanded by optical or mechanical means to encompass a substantial portion of the bath 502. The flow rate of water into and out of the bath 502 may be controlled by the computer system 18 to insure that the water 12 remains in the bath 502 and exposed to UV laser light for a sufficient period of time to provide a desired level of sanitization. The computer system 18 may adjust the flow rate to compensate for a variety of factors, including turbidity.

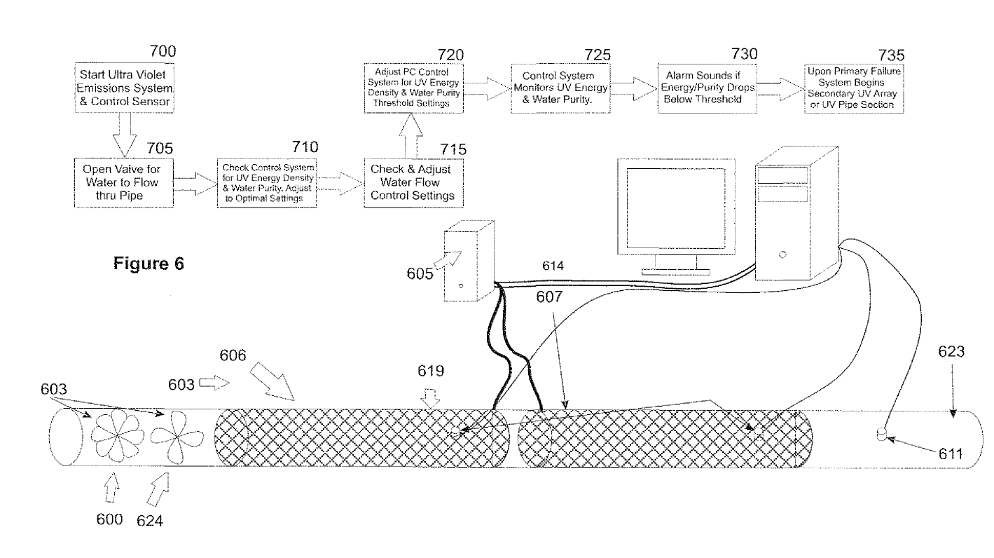

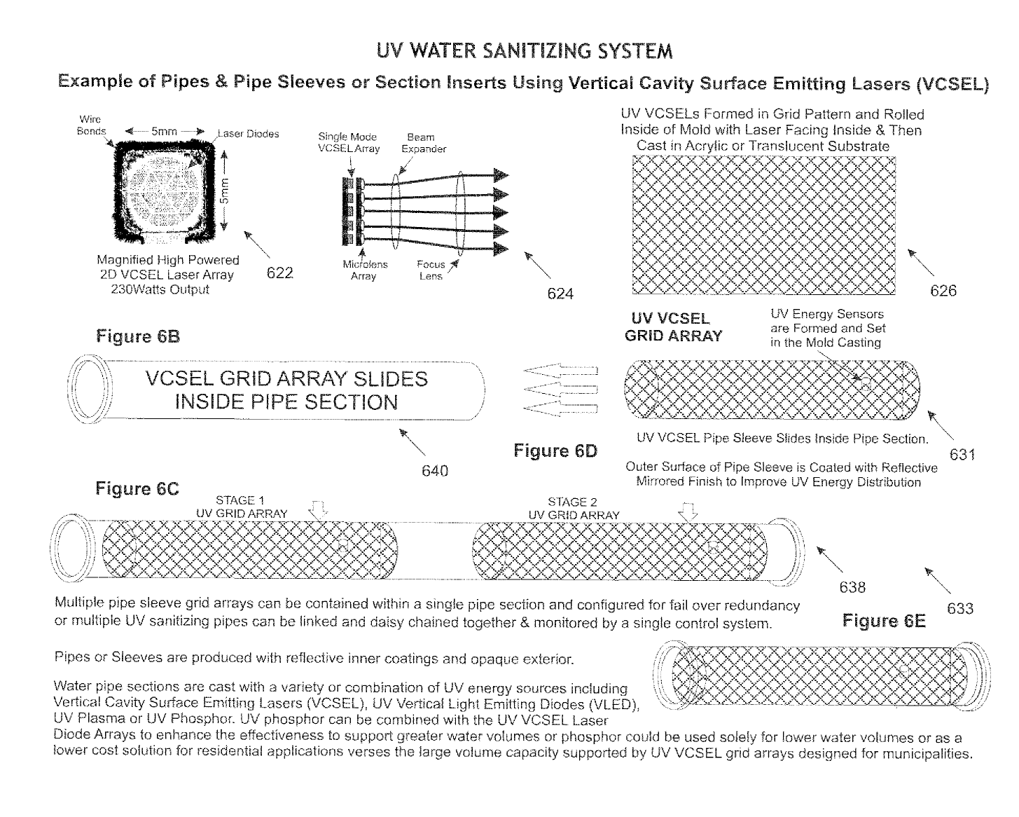

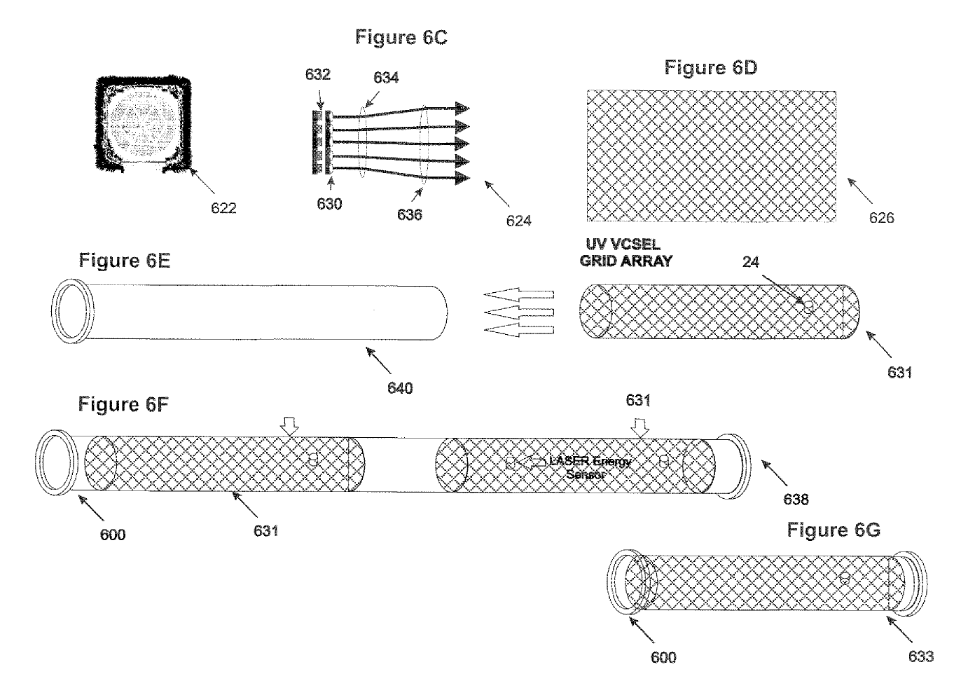

An alternative embodiment of the instant invention is shown in FIGS. 6A-6E and FIG. 7. Generally, the embodiment illustrated herein is comprised of a pipe 600 formed from a material that allows UV light to pass therethrough. In some embodiments of the instant invention at least an interior region of the pipe 600 may be formed from translucent, transparent, or otherwise optically neutral material. UV light sources 606 are disposed adjacent or within this interior region and arranged to project UV light into an interior chamber of the pipe 600, through which water to be sterilized is flowing. In one particular embodiment, the pipe 600 may be formed or cast from acrylic, glass, or other translucent or transparent material with one or more grids or matrices of UV light sources 606 located therein. It is envisioned that hundreds, or even thousands, of the light sources 606 may be disposed therein to provide sufficient UV light to effectively sanitize the water flowing through the pipe 600. The UV light sources 606 may take on any of a variety of forms, such as UV Vertical Light Emitting Diodes (“VLEDs”), Vertical Cavity Surface Emitting Lasers (“VCSELs”), UV Edge Emitting Lasers (“EELs”), UV plasma devices, or UV phosphor devices.

A power source 605 is electrically coupled to the UV light sources 606. The computer control system 18 is coupled to the power source 605, and operates to modify or control the amount of power delivered to the UV light sources 606 to provide a desired level of sanitization for the water flowing through the pipe 600. In some embodiments of the instant invention, it may be useful to provide feedback sensors 610, 611 to ensure that a desired level of sanitization is being accomplished. The feedback sensor 610 may take the form of a UV energy sensor, which provides a feedback signal to the computer control system 18 indicating the amount of energy being delivered from the UV light sources 606.

The computer control system 18 uses the feedback signal to controllably adjust the power source 605 to increase or decrease the power delivered to the UV light sources 606 to match the measured (actual) energy with the energy desired by the computer control system 18.

Additionally or alternatively, the feedback sensor 611 may take the form of a water purification sensor. The water purification sensor 611 can provide a feedback signal to the computer control system 18, which the computer control system 18 may use to adjust the energy being delivered from the UV light sources 606. In the event that the water purification sensor 611 indicates that the purity of the water falls below a preselected setpoint, then the computer control system 18 may increase the power being delivered from the power source 605 to increase the energy supplied by the UV light sources 606 and provide an additional sanitizing affect. Alternatively, if the water purification sensor 611 indicates that the purity of the water is above a preselected setpoint, then the computer control system 18 may reduce the power being delivered from the power source 605 to provide a reduced sanitizing affect.

In some embodiments of the instant invention, it may be useful to have an additional grid of UV light sources 606 positioned downstream of the purification sensor 611, so that additional sanitizing may be performed in the event that the purification sensor 611 indicates that the purity of the water is below a preselected setpoint.

Over time, the effectiveness of the UV light sources 606 may be reduced. Accordingly, it may be useful to employ two or more grids of UV light sources 606 so that the additional grids may be energized as the original grid of UV light sources 606 become less effective. In this manner, the useful life of the water sanitizing system may be extended.

In some embodiments of the instant invention, the effectiveness of the UV light sources 606 may be enhanced by placing a reflective coating or layer 623 around the transparent or translucent section of the pipe 600. In this manner, light emitted from the UV light sources 606 may be reflected back into the interior chamber of the pipe 600 to further enhance the sanitizing effect of the UV light.

Likewise, as can be seen in FIGS. 6B and 6C, the effectiveness of the UV light sources 606 may be enhanced by the use of optics to expand and/or focus the UV light. For example, as shown in FIG. 6C, a microlens array 630 may be positioned adjacent a VCSEL array 632 to focus the UV light emitted by each of the individual VCSELs. Thereafter, an expander 634 and focus lens 636 may be used to create the desired optical pattern of UV light. Additionally, Fresnel lenses may be used in conjunction with the UV light sources 606 to focus the UV light and create greater energy density, and thus, a greater sanitizing effect.

One embodiment of a method that may be employed to manufacture the pipe 600 and the grid of UV light sources 606 is shown in FIGS. 6D-6G. As shown in FIG. 6D, the process begins by forming a generally flat grid 626 of UV light sources 606. In FIG. 6E, the flat grid 626 is rolled into a tube shape, placed in a mold, and cast in a transparent or translucent material, such as an acrylic, to form a sleeve 631. One or more of the sleeves 631 are then slid into a pipe section 640 to form a pipe 600 that is capable of using UV light to sanitize water passing therethrough. FIG. 6F illustrates a pipe 600 in which a single sleeve 631 is disposed therein. FIG. 6G illustrates a pipe in which two sleeves 631 are serially disposed therein.

One process for sanitizing water using the embodiments described in FIGS. 6A-6G is set forth in a flow chart in FIG. 7. The process begins at block 700 with the UV sanitizing system being turned on. At block 705, a valve is opened and water begins flowing through the pipe 600. Signals from the feedback sensors 610, 611 are evaluated by the computer control system 18 at block 710. The computer control system 18 determines whether the UV light energy is at the desired level, and, if not, adjusts the power level supplied by the power supply 605 to the UV light sources 606. At block 715, the computer control system 18 receives signals indicative of the actual flow rate of the water in the pipe 600, and adjusts the setting of a control valve to maintain a desired flow rate. After any adjustment to the parameters of the system, such as power settings or flow rate, the computer control system 18 monitors the energy density and purity to determine if the adjustments have had the desired effect at blocks 720, 725. If not, and the water purity drops below a desired level, an alarm is sounded at block 730 to alert personnel of a problem that requires attention. At block 735, in the event that the system employs two UV grids 631, then the secondary grid may be energized to assist in the sanitizing process.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method for sanitizing water, the method comprising:
directing ultraviolet light into a conduit capable of carrying water therein;
measuring an intensity of the ultraviolet light within the conduit; and
controlling the intensity of the ultraviolet light introduced into the conduit based on the measured intensity of ultraviolet light within the conduit to provide sanitized water.

2. A method, as set forth in claim 1, wherein directing ultraviolet light into the conduit further comprises directing ultraviolet light through a sidewall in conduit in a direction transverse to the direction of flow of water within the conduit.

3. A method, as set forth in claim 1, wherein directing the ultraviolet light into the conduit further comprises directing ultraviolet light through a sidewall in conduit in a direction transverse to a direction of flow of water within the conduit and expanding the path of the ultraviolet to illuminate a substantial portion of a cross sectional region of the conduit.

4. A method, as set forth in claim 1, wherein directing ultraviolet light into the conduit further comprises directing ultraviolet light through a sidewall in the conduit in a direction substantially coaxial to a direction of flow of water within the conduit.

5. A method, as set forth in claim 1, wherein directing ultraviolet light into the conduit further comprises directing ultraviolet light through a sidewall in the conduit in a direction substantially coaxial to a direction of flow of water within the conduit and expanding the path of the ultraviolet to illuminate a substantial portion of a cross sectional region of the conduit.

6. A method, as set forth in claim 1, further comprising disturbing the flow of water in the conduit in a region adjacent a location where the ultraviolet light is introduced into the conduit.

7. A method, as set forth in claim 1, wherein directing ultraviolet light into the conduit further comprises directing ultraviolet laser light into the conduit.

8. A method for sanitizing water, the method comprising:
directing ultraviolet light into a conduit capable of carrying water therein;
measuring a parameter of the water within the conduit associated with sanitization of the water; and
controlling the intensity of the ultraviolet light introduced into the conduit based on the measured parameter of the water.

9. A method, as set forth in claim 8, wherein directing ultraviolet light into the conduit further comprises directing ultraviolet light through a sidewall in conduit in a direction transverse to the direction of flow of water within the conduit.

10. A method, as set forth in claim 8, wherein directing the ultraviolet light into the conduit further comprises directing ultraviolet light through a sidewall in conduit in a direction transverse to a direction of flow of water within the conduit and expanding the path of the ultraviolet to illuminate a substantial portion of a cross sectional region of the conduit.

11. A method, as set forth in claim 8, wherein directing ultraviolet light into the conduit further comprises directing ultraviolet light through a sidewall in the conduit in a direction substantially coaxial to a direction of flow of water within the conduit.

12. A method, as set forth in claim 8, wherein directing ultraviolet light into the conduit further comprises directing ultraviolet light through a sidewall in the conduit in a direction substantially coaxial to a direction of flow of water within the conduit and expanding the path of the ultraviolet to illuminate a substantial portion of a cross sectional region of the conduit.

13. A method, as set forth in claim 8, further comprising disturbing the flow of water in the conduit in a region adjacent a location where the ultraviolet light is introduced into the conduit.

14. A method, as set forth in claim 1, wherein directing ultraviolet light into the conduit further comprises directing ultraviolet laser light into the conduit.

15. An apparatus for sanitizing water, the apparatus comprising:
a container for housing water;
an ultraviolet light; and
means for transmitting the ultraviolet light into the container housing the water.

16. An apparatus, as set forth in claim 15 wherein the ultraviolet light further comprises an ultraviolet laser.

17. An apparatus, as set forth in claim 15, further comprising:
a sensor for measuring a parameter of the water associated with sanitization of the water; and
a controller for controlling the intensity of the ultraviolet light introduced into the container based on the measured parameter.

18. An apparatus, as set forth in claim 15, further comprising:
a sensor for measuring an intensity of the ultraviolet light within the water; and
a controller for controlling the intensity of the ultraviolet light introduced into the conduit based on the measured intensity of ultraviolet light within the conduit to provide sanitized water.

19. An apparatus, as set forth in claim 15, wherein the container is a conduit configured to receive flowing water therein and wherein the means for transmitting the ultraviolet light into the conduit further comprises a port for receiving ultraviolet into the conduit along a path that is substantially transverse to the direction of water flowing in the conduit.

20. An apparatus, as set forth in claim 15, wherein the container is a conduit configured to receive flowing water therein and wherein the means for transmitting the ultraviolet light into the conduit further comprises a port for receiving ultraviolet into the conduit along a path that is substantially coaxial to the direction of water flowing in the conduit.
